(19) United States
(12) Patent Application Publication
(10) Pub. No.: US 2024/0252398 A1
(43) Pub. Date: Aug. 1, 2024

(54) LIQUID TRANSFER DEVICE WITH VALVE

(71) Applicant: West Pharma. Services IL, Ltd., Ra'anana (IL)

(72) Inventor: Elisheva FABRIKANT, Herzliya (IL)

(21) Appl. No.: 18/578,366

(22) PCT Filed: Jul. 18, 2022
(86) PCT No.: PCT/IL22/50772

§ 371 Date: Jan. 11, 2024

Related U.S. Application Data
(60) Provisional application No. 63/223,318, filed on Jul. 19, 2021.

(51) Int. Cl. A61J 1/20

(52) U.S. Cl. CPC A61J 1/20

(57) ABSTRACT

A liquid transfer device is described. The liquid transfer device includes an IV spike configured to connect to an infusion liquid container; a compactable vial adaptor configured to mount onto a vial; an IV port configured to connect to an infusion set; and a valve movable between a first state and a second state upon compaction of the vial adaptor. The valve is configured to prevent fluid communication between the IV spike, the vial adaptor and the IV port in the first state, and the valve is configured to provide fluid communication between the IV spike and the vial adaptor, and fluid communication between the IV spike and the IV port in the second state.

### BACKGROUND

The present disclosure is generally directed to liquid transfer devices.

Conventional infusion liquid containers containing an infusion liquid to be delivered to a patient generally take the form of an infusion liquid bag (or infusion liquid container), an infusion liquid bottle, and the like. A pre-filled syringe or vial is generally utilized to add a high concentration of a drug to the infusion liquid contents, via a liquid transfer device, to form a diluted, medicated infusion liquid. Thereafter, an infusion set including an IV spike may be inserted into an IV port of the liquid transfer device for infusion of medicated infusion liquid contents to a patient. Minimizing the risk of a patient receiving a portion of the drug in a highly concentrated, undiluted form is important for patient safety. The present disclosure offers an improved liquid transfer device for infusion of a diluted, medicated infusion liquid contents to a patient.

### BRIEF SUMMARY

According to a first embodiment, a liquid transfer device comprise an IV spike configured to connect to an infusion liquid container, a compactable vial adaptor configured to mount onto a vial, an IV port configured to connect to an infusion set, and a valve movable between a first state and a second state upon compaction of the vial adaptor. The valve is preferably configured to prevent fluid communication between the IV spike, the vial adaptor and the IV port in the first state and to provide fluid communication between the IV spike and the vial adaptor, and fluid communication between the IV spike and the IV port in the second state.

In one aspect, the IV spike of the liquid transfer device may comprise a first IV spike lumen and a second IV spike lumen configured to provide fluid communication with the infusion liquid container.

In another aspect, the valve of the liquid transfer device may be configured to provide fluid communication between the first IV spike lumen and the vial adaptor and between the second IV spike lumen and the IV port in the second state.

In another aspect, the valve of the liquid transfer device may comprise a first lumen configured to provide fluid communication between the first IV spike lumen and the vial adaptor, and a second lumen configured to provide fluid communication between the second IV spike lumen and the IV port.

In another aspect, the vial adaptor of the liquid transfer device may comprise a vial spike to puncture a vial stopper of the vial to provide fluid communication with the vial.

In another aspect, the vial adaptor of the liquid transfer device may comprise an outer vial adaptor body and an inner vial adaptor body configured to mount onto a vial, wherein the inner vial adaptor body is configured to slide within the outer vial adaptor body when the vial adaptor undergoes compaction from a non-compacted state to a compacted state.

In another aspect, the vial spike of the liquid transfer device may be configured to puncture the vial stopper when the vial adaptor undergoes compaction.

In another aspect, the liquid transfer device may be further comprise a valve actuator movable between a first position and a second position, wherein the valve actuator is configured to move from the first position to the second position upon compaction of the vial adaptor.

In another aspect, the valve actuator of the liquid transfer device may be configured to drive the valve from the first state when the valve actuator is in the first position to the second state when the valve actuator is in the second position upon compaction of the vial adaptor.

In another aspect, the valve of the liquid transfer device may comprise an angled face configured to engage with the valve actuator.

In another aspect, the liquid transfer device may further comprise a safety catch which is configured to prevent compaction of the vial adaptor in the non-compacted state.

In another aspect, the liquid transfer device may further comprise a connector body having the IV spike, the vial adaptor and the IV port coupled thereto, wherein the valve is movable within the connector body between the first state and the second state.

In another aspect, the liquid transfer device may further comprise a bore, and the valve may further comprise a locking protrusion, wherein the locking protrusion is configured to engage with the bore to prevent movement of the valve between the first state and the second state in the pre-compacted state and wherein the locking protrusion is configured to deflect and disengage from the bore such that the valve is movable between the first state and the second state in the compacted state.

These and other aspects of the liquid transfer device disclosed herein will be apparent in view of the following description.

### BRIEF DESCRIPTION OF THE SEVERAL VIEWS OF THE DRAWINGS

The present disclosure can be understood with reference to the description of the embodiments set out below, in conjunction with the appended drawings in which:

FIG. 1 illustrates a liquid transfer device according to an embodiment of the invention coupled to infusion liquid container, a vial and an infusion set;

FIG. 2 illustrates an exploded view of the liquid transfer device and the vial illustrated in FIG. 1;

FIG. 3 illustrates a perspective view of the liquid transfer device in a pre-compacted state, the vial illustrated in FIG. 1, and a pincers-like hand tool for releasing the non-punctured vial from a vial adaptor of the liquid transfer device;

FIG. 4 illustrates a side view of the liquid transfer device in a pre-compacted state, the vial illustrated in FIG. 1 and the pincers-like hand tool for releasing the non-punctured vial from the vial adaptor;

FIG. 5 illustrates a side elevation view of the valve (5A), a side view of the valve illustrated in FIG. 2 (5B), a bottom view of the valve (5C), and a cross-sectional view of the valve illustrated in FIG. 2 (5D);

FIG. 6 illustrates a cross-sectional view of the liquid transfer device in the pre-compacted state.

FIG. 7 illustrates a cross-sectional view of the liquid transfer device in a compacted state.

FIG. 8 illustrates a cross-sectional view of the liquid transfer device in the pre-compacted state (8A) and a cross-sectional view of the liquid transfer device in the compacted state (8B);

FIG. 9 illustrates is a side view of the liquid transfer device including a releasable safety catch, prior to mounting the liquid transfer device onto the vial illustrated in FIG. 1;

FIG. 10 illustrates a cross-sectional view of the liquid transfer device including the releasable safety catch, prior to mounting the liquid transfer device onto the vial illustrated in FIG. 1;

FIG. 11 illustrates a side view of the liquid transfer device in the pre-compacted state, including the releasable safety catch and the vial illustrated in FIG. 1; and

FIG. 12 illustrates a side view of the liquid transfer device showing the removal of the releasable safety catch and the compaction of the vial adaptor.

### DETAILED DESCRIPTION

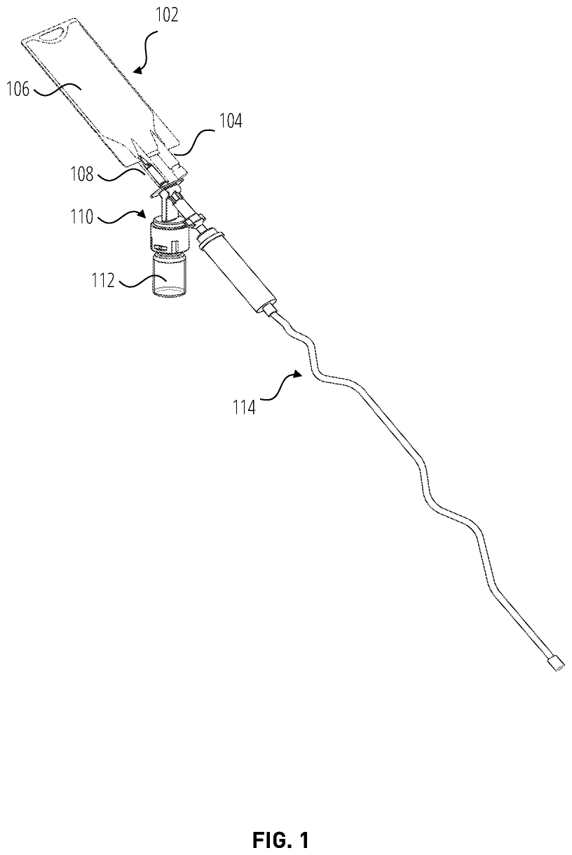

FIG. 1 illustrates a liquid transfer device 110, in accordance with a first embodiment of the present invention. As shown in FIG. 1, the liquid transfer device 110 is intended for use with an infusion liquid container 102 or infusion liquid bag and an infusion set 114. As should be understood by those of ordinary skill in the art, the infusion liquid container 102 includes a reservoir 106 containing infusion liquid, in fluid communication with an intravenous administration port 108 and an additive port 104. The liquid transfer device 110 of the illustrated embodiment is also intended for use with an additive transfer device in the form of a sealed vial 112. The vial 112 generally contains a highly concentrated medicament liquid additive or a lyophilized powder drug requiring reconstitution prior to administration to a patient, i.e., requiring mixing with the infusion liquid in the infusion liquid container 102 to form a medicated infusion liquid to be administered to a patient. The contents of the vial 112 are, therefore, introduced into the infusion liquid container 102 via the liquid transfer device 110.

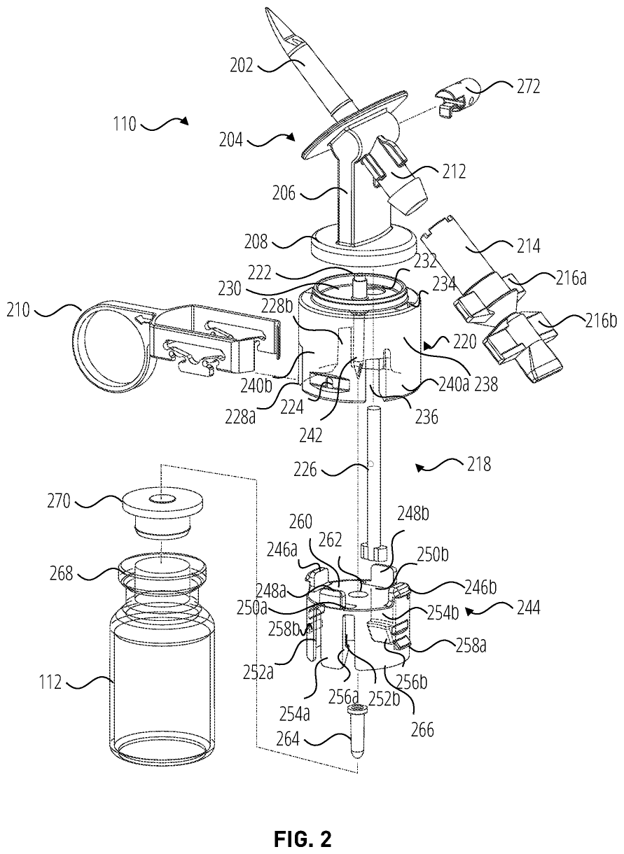

FIG. 2 illustrates the vial 112 has a tubular vial crown 268 having a vial stopper 270 for hermetically sealing the vial 112. The vial 112 contains a medicament (not shown in FIG. 2) for introduction into the infusion liquid to form a medicated infusion liquid.

The liquid transfer device 110 comprises a connector body 204. In this embodiment, the connector body 204 has a flow control body 206 on a first limb, an IV port holder 212 on a second limb, and an IV spike 202 on a third limb. The liquid transfer device 110 includes a vial adaptor 218 mounted on the flow control body 206.

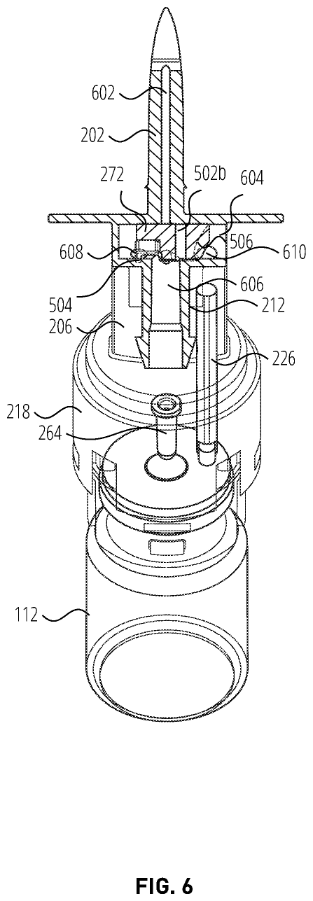

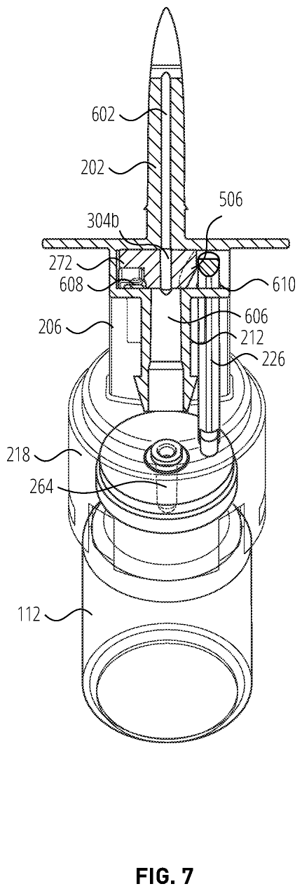

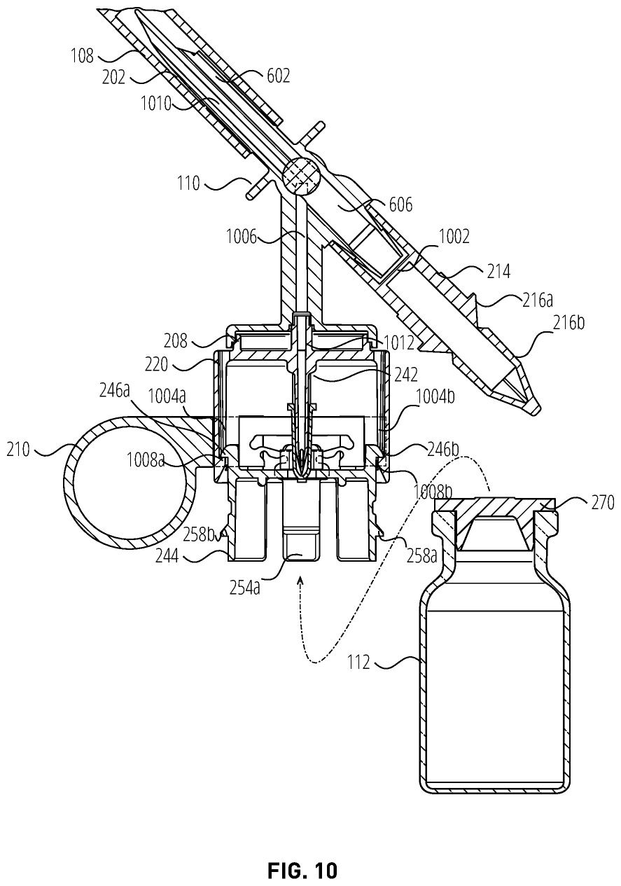

The flow control body 206 includes a flow control lumen 1006 (see FIG. 10), a bore 608 (see FIG. 6), a valve actuator bore 610 (see FIG. 6), a valve 272 and a valve cavity 604 (see FIG. 6). As shown in FIG. 6 and FIG. 7, the valve 272 is movably housed within the valve cavity 604. The flow control body 206 terminates in a vial adaptor flange 208 for mounting on the vial adaptor 218. The valve actuator bore 610 extends from the valve cavity 604 to the vial adaptor flange 208.

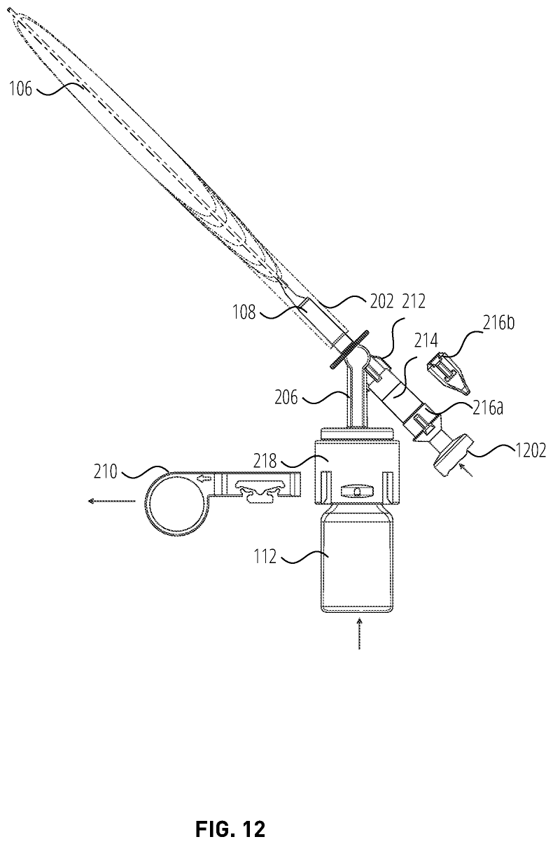

The IV port holder 212 is configured to receive an IV spike 202 of an infusion set 114 for administration purposes. Attached to the IV port holder 212 is an IV port 214 sealed by a twist-off cap which includes a proximal section 216a and a distal section 216b. The IV port 214 includes a septum 1002 (see FIG. 10) which is sealed prior to being punctured on insertion of the IV spike 202 of the infusion set 114. As shown in FIG. 12, the distal section 216b is twisted and broken off from the proximal section 216a thereby exposing the septum 1002 for puncturing by a spike 1202 of the infusion set 114 (see FIG. 12). As shown in FIG. 6, the IV port holder 212 has an IV port holder lumen 606 in fluid communication with a valve cavity 604 and thus the valve 272.

The IV spike 202 enables use of the liquid transfer device 110 with the infusion liquid container 102, i.e., for sealingly inserting the IV spike 202 into the intravenous administration port 108 of the infusion liquid container 102. The IV spike 202 is co-directional with the IV port holder 212. As shown in FIG. 10, the IV spike 202 includes a first IV spike lumen 602 and a second IV spike lumen 1010 configured to provide two discrete fluid communication paths between the infusion liquid container 102 and the valve cavity 604, and thus the valve 272. In the illustrated configurations, the first IV spike lumen 602 and the second IV spike lumen 1010 extend generally parallel to one another.

FIG. 2 also shows the vial adaptor 218. The vial adaptor 218 comprises an inner vial adaptor body 244 and an outer vial adaptor body 220 and is intended to undergo compaction from an initial pre-compacted state (or non-compacted state) to a final compacted state (or compacted state) in which the outer vial adaptor body 220 slidingly receives the inner vial adaptor body 244 therein. The vial adaptor 218 includes a vial spike 242 for puncturing a vial stopper 270 of the vial 112 in the compacted state of the vial adaptor 218. The vial spike 242 is protected by a thin sheath 264 for maintaining sterility until use of the liquid transfer device 110 for administering a medicated infusion liquid.

The inner vial adaptor body 244 has an inverted cup shape including an upper inner vial adaptor wall 260 and a vial crown sleeve 266. The inner vial adaptor body 244 bounds an inner cavity for receiving the vial crown 268. The upper inner vial adaptor wall 260 includes a central aperture 262.

The vial crown sleeve 266 includes a first pair of longitudinal slits 252a, 252b and a second pair of longitudinal slits (not visible in FIG. 2) for correspondingly forming a diametric pair of vial crown holding members 254a, 254b. The upper inner vial adaptor wall 260 preferably has a diametric pair of cutouts 250a, 250b radially inwards of the vial crown holding members 254a, 254b such that the vial crown holding members 254a, 254b can pivot with respect to the vial crown sleeve 266.

The vial crown holding members 254a, 254b each include a proximal vial crown holding member 248a, 248b and a distal vial crown holding member 256a, 256b. The distal vial crown holding members 256a, 256b project radially inward for snap fitting under the vial crown 268 on mounting the inner vial adaptor body 244 onto the vial 112. The application of a pincers-like compression on the proximal vial crown holding members 248a, 248b pivots the vial crown holding members 254a, 254b with respect to the vial crown sleeve 266 thereby moving the distal vial crown holding member 256a, 256b radially outwards.

The upper inner vial adaptor wall 260 acts upon a valve actuator 226. The valve actuator 226 extends through the outer vial adaptor body 220 and the flow control body 206. A valve actuator bore 610 (see FIG. 6) formed in the flow control body 206 is generally elongated and cylindrical. With reference to FIG. 6 to FIG. 8, the valve actuator 226 is configured to move up and down in the orientation shown within the valve actuator bore 610. Upon compaction of the vial adaptor 218, the valve actuator 226 is configured to move in the valve actuator bore 610 between a first actuator position and a second actuator position.

The upper inner vial adaptor wall 260 has a diametric pair of upright members 246a, 246b correspondingly orthogonal to the diametric pair of vial crown holding members 254a, 254b. The diametric pair of upright members 246a, 246b prevent the inner vial adaptor body 244 from being inadvertently removed from the outer vial adaptor body 220. The vial crown sleeve 266 includes a diametric pair of clamp members 258a, 258b correspondingly orthogonal to the diametric pair of vial crown holding members 254a, 254b.

The outer vial adaptor body 220 has an inverted cup shape including an upper outer vial adaptor wall 230 and an outer vial adaptor skirt 238. The outer vial adaptor body 220 bounds an outer cavity for further receiving the inner vial adaptor body 244 therein on compacting the vial adaptor 218 from the pre-compacted state to the compacted state.

The upper outer vial adaptor wall 230 includes a central connector 222 for insertion in the flow control lumen 1006 and the vial spike 242 to provide fluid communication therethrough. A corresponding flange of the outer vial adaptor body 220 is received by the vial adaptor flange 208. The upper outer vial adaptor wall 230 includes an aperture 232 for the movement therethrough of the valve actuator 226.

The outer vial adaptor body 220 has a diametric pair of slits for receiving the pair of proximal vial crown holding member 248a, 248b and a diametric pair of slits for receiving the pair of upright members 246a, 246b, such as slit 234, in the compacted state of the vial adaptor 218.

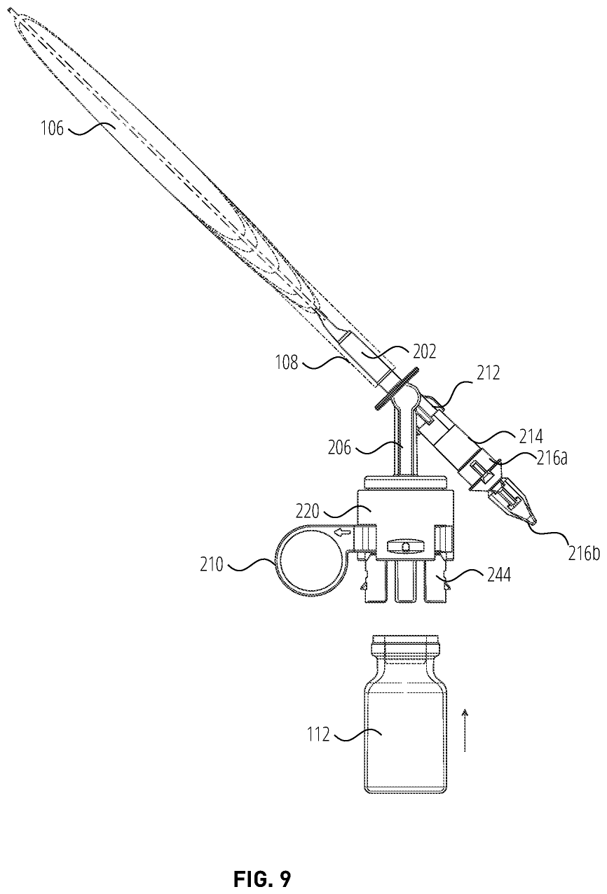

The outer vial adaptor skirt 238 includes a first pair of adjacent longitudinal slits 228a, 228b and a second pair of adjacent longitudinal slits 236 (only one slit is visible in the figure) opposite the first diametric pair of adjacent longitudinal slits for correspondingly forming a diametric pair of inner vial adaptor holding members 240a, 240b. As shown in FIG. 9, a tuning fork-like safety catch 210 transverses the first pair of longitudinal slits 228a, 228b and the second pair of longitudinal slits 236 for preventing compaction of the telescopic vial adaptor.

The diametric pair of inner vial adaptor holding members 240a, 240b have a diametric pair of internal recess 1004a, 1004b (see FIG. 10) to permit movement of the inner vial adaptor body 244 within the outer vial adaptor body 220. The diametric pair of internal recess 1004a, 1004b correspondingly include a diametric pair of lower recess rims 1008a, 1008b (see FIG. 10). In the non-compacted state of the vial adaptor 218, the pair of lower recess rims 1008a, 1008b are configured to receive the pair of upright members 246a, 246b to prevent the inner vial adaptor body 244 from being inadvertently removed from the outer vial adaptor body 220. In the compacted state of the vial adaptor 218, the pair of lower recess rims 1008a, 1008b are configured to receive the pair of clamp members 258a, 258b for irreversibly clamping the vial adaptor 218 in the compacted state.

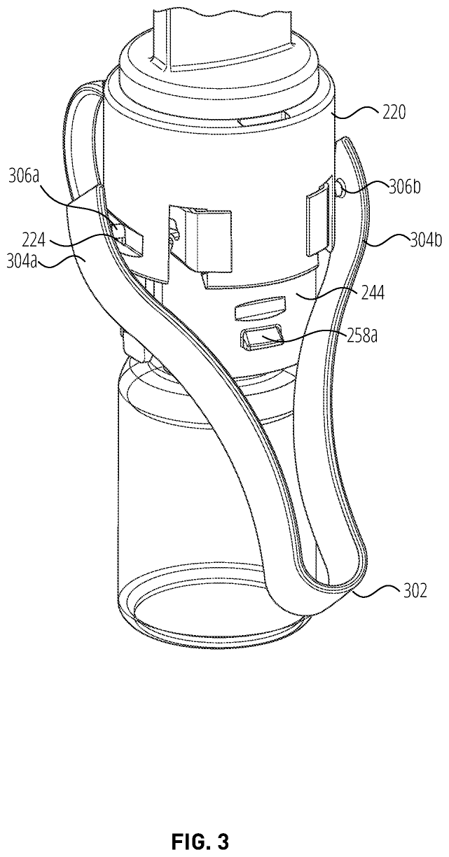

The outer vial adaptor skirt 238 has a diametric pair of apertures 224 (only one aperture is visible in the figure) orthogonal to the pair of inner vial adaptor holding members 240a, 240b. The pair of aperture 224 are designed with the use of a pincers-like hand tool 302 (see FIG. 3) to facilitate manual application of a pincers-like compression for releasing a non-punctured vial 112.

The vial spike 242 includes a vial spike lumen 1012 (see FIG. 10) to provide fluid communication with the vial 112 when compacted. The vial spike lumen 1012 is in fluid communication with the flow control lumen 1006 (see FIG. 10).

FIG. 3 illustrates the pincers-like hand tool 302 for releasing a non-punctured vial 112. The pincers-like hand tool 302 includes a pincers-like body with an opposing pair of jaws 304a, 304b each terminating at an inwards directed protrusion 306a, 306b. The opposing pair of jaws 304a, 304b can be manually urged towards one another for applying a pincers-like compression for releasing the non-punctured vial 112.

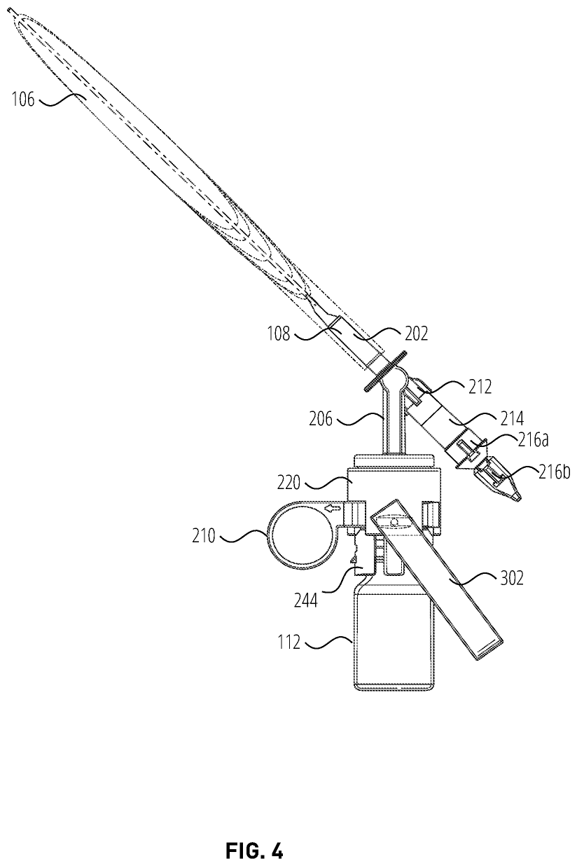

FIG. 4 illustrates the pincers-like hand tool 302 with the vial 112, the vial adaptor 218, and the fluid reservoir 106.

If it is decided to not administer the medicament after a vial 112 has been attached to a liquid transfer device 110, which has not been compacted, and to re-use the non-punctured vial 112, a user may take the following steps. The user aligns the pincers-like hand tool 302 with the vial adaptor 218 for inserting the pair of inwards directed protrusions 306a, 306b, through the pair of apertures 224. The user applies a pincers-like compression on the pair of proximal vial crown holding members 248a, 248b for urging them radially inwards. The pair of vial crown holding members 254a, 254b pivot with respect to the vial crown sleeve 266 thereby distancing the distal vial crown holding members 256a, 256b radially outwards to release the non-punctured vial 112. The user withdraws the non-punctured vial 112 from the inner vial adaptor body 244 for subsequent use.

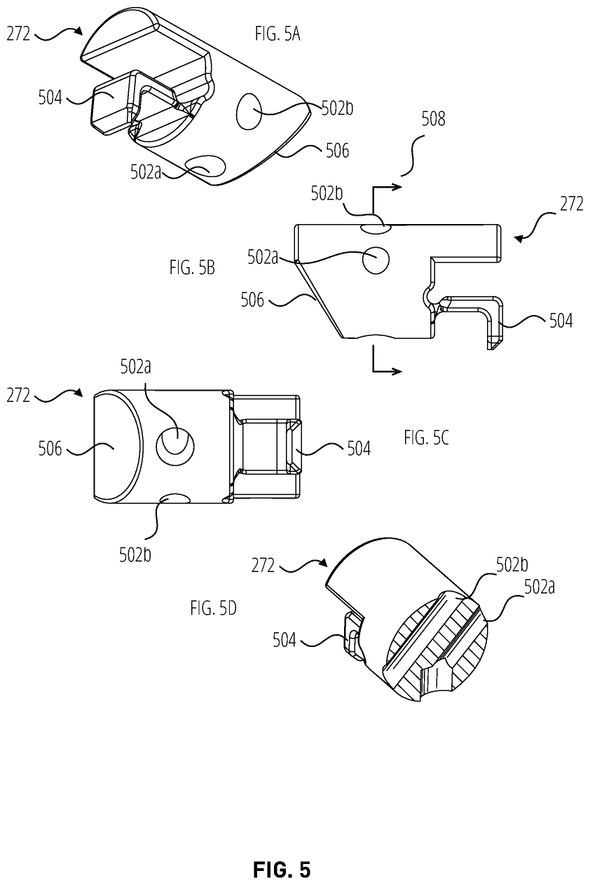

FIG. 5 illustrates the valve 272. FIG. 5A-5C show different perspective views of the valve 272. FIG. 5A shows a cross section 508 of the valve 272 to illustrate lumens 502a, 502b in the valve 272. The angled first lumen 502a is configured to provide fluid communication between the second IV spike lumen 1010 and the flow control lumen 1006 (see FIG. 10). The straight second lumen 502b is configured to provide fluid communication between the first IV spike lumen 602 and the IV port holder lumen 606 (see FIG. 6). Thus, fluid communication between the IV spike 202 and the vial adaptor 218 is separated from fluid communication between the IV spike 202 and the IV port holder 212. The valve 272 may further comprise an angled face 506. The valve 272 includes a locking protrusion 504. The first lumen 502a and the second lumen 502b may both be angled, or the first lumen 502a may be straight and the second lumen 502b may be angle depending on the configuration of the liquid transfer device 110. Reference to an angled lumen refers to the first lumen 502a or second lumen 502b having a bend or change of flow direction with respect to a straight flow direction or fluid flow path.

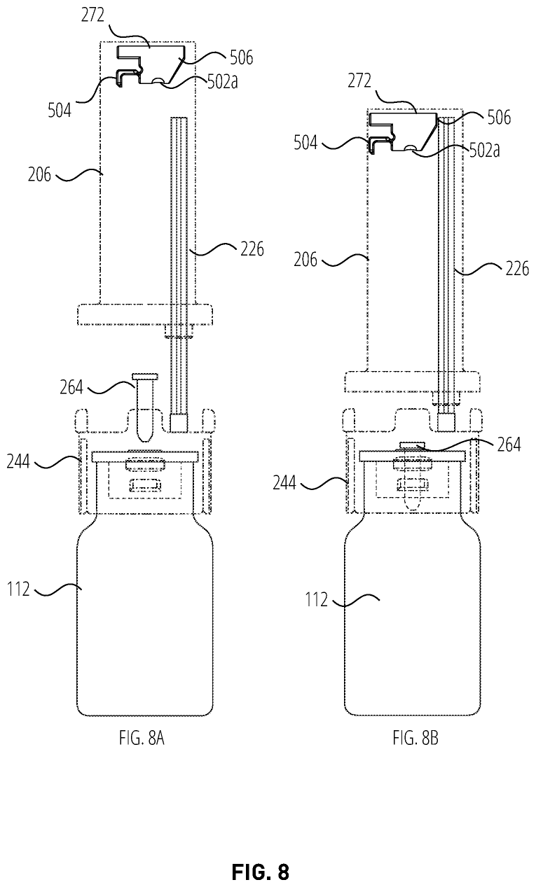

Referring to FIG. 6 and FIG. 7, the valve 272 is movable within the valve cavity 604. The valve cavity 604 is generally cylindrical and elongated. With reference to FIG. 6 to FIG. 8, the valve 272 moves left and right in the orientation within the valve cavity 604 between a first position (see FIG. 6) and a second position (see FIG. 7). Prior to compaction, the locking protrusion 504 engages with the bore 608, thereby preventing movement of the valve 272 to the left. Upon compaction, the valve actuator 226 moves within the valve actuator bore 610 between a first actuator position and a second actuator position, as seen in FIG. 8A and FIG. 8B. The valve actuator 226 engages with the angled face 506 of the valve 272, thereby moving the valve 272 to the left. As the valve actuator 226 urges against the angled face 506 of the valve 272, the locking protrusion 504 is configured to deflect, thereby disengaging from the bore 608, such that the valve 272 moves from the first position on the right to the second position on the left within the valve cavity 604.

The valve 272 is configured to prevent fluid communication between the second IV spike lumen 1010 and the flow control lumen 1006 in the first position (or first state), which corresponds to a non-compacted state of the vial adaptor 218. In other words, the second IV spike lumen 1010, the first lumen 502a of the valve 272, and the flow control lumen 1006 are not in fluid communication in the first position. Similarly, the valve 272 is configured to prevent fluid communication between the first IV spike lumen 602 and the IV port holder lumen 606 in the first state. In other words, the first IV spike lumen 602, the second lumen 502b of the valve 272, and the IV port holder lumen 606 are not in fluid communication in the first state. As shown in FIG. 7, the valve 272 is configured to allow fluid communication between the first IV spike lumen 602 and the IV port holder lumen 606 in the second state (or second position), which corresponds to a compacted state of the vial adaptor 218. In other words, the first IV spike lumen 602, the second lumen 502b and the IV port holder lumen 606 are in fluid communication in the second state. Similarly, the valve 272 is configured to allow fluid communication between the second IV spike lumen 1010 and the flow control lumen 1006 in the second state. In other words, the second IV spike lumen 1010, the first lumen 502a, and the flow control lumen 1006 are in fluid communication in the second state.

Thus, when the vial adaptor 218 is in the pre-compacted state, fluid communication between the IV spike 202, the vial adaptor 218 and the IV port holder 212 is prevented. Upon compaction of the vial adaptor 218, fluid communication between the IV spike 202, the vial adaptor 218 and the IV port holder 212 is permitted.

Rotation of the valve 272 within valve cavity 604 when sliding the valve 272 from the first state to the second state may result in misalignment of first lumen 502a with second IV spike lumen 1010 and flow control lumen 1006, as well as misalignment of second lumen 502 b with first IV spike lumen 602 and the IV port holder lumen 606. To ensure that the valve 272 maintains it rotational position while sliding, one or more features may be included on the outer surface of the valve 272 and/or inner surface of the valve cavity 604. For example, the inner surface of the valve cavity 604 may be provided with a groove and the outer surface of the valve 272 may be provided with a corresponding rail (not shown) and vice versa.

FIG. 8 illustrates a cross-section of the liquid transfer device 110 before and after compaction of the vial adaptor 218. As shown in FIG. 8A, the vial adaptor 218 is mounted onto the vial 112. Upon compaction, the inner vial adaptor body 244 moves the valve actuator 226 from the first actuator position (see FIG. 8A) to the second actuator position (see FIG. 8B). The valve actuator 226 engages with angled face 506 of the valve 272, causing the valve 272 to move within the valve cavity 604 between the first position (see FIG. 8A) and the second position see FIG. 8B).

FIG. 9 illustrates an arrangement of the liquid transfer device 110 with the safety catch 210 traversing the outer vial adaptor body 220 for preventing compaction of the vial adaptor 218. The vial adaptor 218 is in the pre-compacted state and the valve 272 is in the first position, preventing fluid communication between the IV spike 202, the IV port holder 212 and the vial 112.

FIG. 10 illustrates a cross section of the liquid transfer device 110 coupled to reservoir 106, and a vial 112.

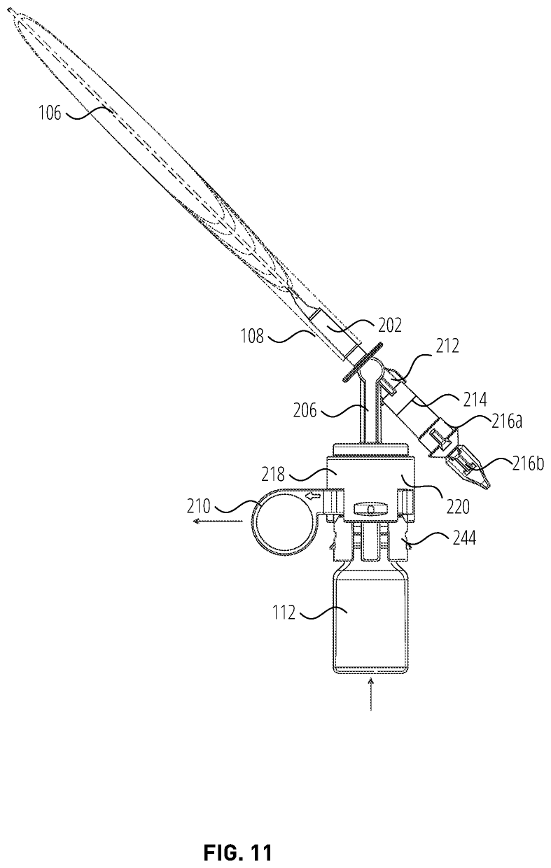

FIG. 11 shows the liquid transfer device 110 after the user mounts the vial adaptor 218 onto the injection vial 112 ready for preparation of medicated infusion liquid in the infusion liquid container 102 for subsequent administration to a patient.

FIG. 12 illustrates liquid transfer device 110 after the user has withdrawn the safety catch 210 from the outer vial adaptor body 220 and compacted the vial adaptor 218 such that the outer vial adaptor body 220 receives the inner vial adaptor body 244 therein. The vial spike 242 punctures the vial stopper 270 for providing fluid communication between the vial spike lumen 1012 and the vial 112 for preparing a medicated infusion liquid. The compaction precludes any subsequent use of the pincers-like hand tool 302 to release the now punctured discrete injection vial 112 because the proximal vial crown holding members 248a, 248b will no longer be aligned with apertures 224.

Referring to FIG. 12, the safety catch 210 may be removed after the inner vial adaptor body 244 of the vial adaptor 218 has been mounted onto the vial 112, and prior to compaction. The vial adaptor 218 can then be compacted from the pre-compacted state to the compacted state, as shown in FIG. 6. A spike 1202 of the infusion set 114 is illustrated which can be inserted into the IV port 214 after the distal section 216b, or twist-off cap has been removed, or twisted-off.

The use of the liquid transfer device 110 is now described with reference to FIG. 3 to FIG. 12. A user (e.g. a healthcare professional) inserts a vial 112 into the inner vial adaptor body 244 of the vial adaptor 218, such that the liquid transfer device 110 is ready for further use, but the user may leave the liquid transfer device 110 unattended for later use without immediately performing subsequent steps. Inadvertent compaction of the vial adaptor 218 of the liquid transfer device 110 is prevented by the safety catch 210. When the user is ready to mix the contents of the vial 112 with the fluid within the infusion liquid container 102, the user inserts the IV spike 202 into the intravenous administration port 108 of the infusion liquid container 102 and removes the safety catch 210. The user compacts the vial adaptor by pushing the vial 112 and the inner vial adaptor body 244 into the outer vial adaptor body 220.

Upon compaction of the vial adaptor 218, the vial spike 242 punctures the sheath 264 and thereafter the vial stopper 270 to establish flow communication between the vial spike 242 and the vial 112 for preparing a medicated infusion liquid. The user prepares the medicated infusion liquid in the reservoir 106 of the infusion liquid container 102 by transferring liquid between the reservoir 106 and the vial 112 via the vial spike lumen 1012, the flow control lumen 1006, the first lumen 502a, and the second IV spike lumen 1010. To administer the medicated infusion liquid, the user removes distal section 216b of the IV port 214 and inserts a spike 1202 of the infusion set 114 therein. The prepared medicated infusion liquid can now be administered to a patient with the infusion set 114 via the first IV spike lumen 602, the second lumen 502b, and the IV port holder lumen 606.

While particular embodiments of the present invention are illustrated and described, it would be obvious to those skilled in the art that various other changes and modifications can be made without departing from the spirit and scope of the invention.

1. A liquid transfer device, comprising:
an IV spike configured to connect to an infusion liquid container;
a compactable vial adaptor configured to mount onto a vial;
an IV port configured to connect to an infusion set; and
a valve movable between a first state and a second state upon compaction of the vial adaptor,
wherein the valve is configured to prevent fluid communication between the IV spike, the vial adaptor and the IV port in the first state, and
wherein the valve is configured to provide fluid communication between the IV spike and the vial adaptor, and fluid communication between the IV spike and the IV port in the second state.

2. The liquid transfer device of claim 1, wherein the IV spike comprises a first IV spike lumen and a second IV spike lumen configured to provide fluid communication with the infusion liquid container.

3. The liquid transfer device of claim 2, wherein the valve is configured to provide fluid communication between the first IV spike lumen and the vial adaptor and between the second IV spike lumen and the IV port in the second state.

4. The liquid transfer device of claim 2, wherein the valve comprises a first lumen configured to provide fluid communication between the first IV spike lumen and the vial adaptor, and a second lumen configured to provide fluid communication between the second IV spike lumen and the IV port.

5. The liquid transfer device of claim 1, wherein the vial adaptor comprises a vial spike to puncture a vial stopper of the vial to provide fluid communication with the vial.

6. The liquid transfer device of claim 5, wherein the vial adaptor comprises an outer vial adaptor body and an inner vial adaptor body configured to mount onto a vial, wherein the inner vial adaptor body is configured to slide within the outer vial adaptor body when the vial adaptor undergoes compaction from a non-compacted state to a compacted state.

7. The liquid transfer device of claim 6, wherein the vial spike is configured to puncture the vial stopper when the vial adaptor undergoes compaction.

8. The liquid transfer device of claim 6, further comprising a valve actuator movable between a first position and a second position, wherein the valve actuator is configured to move from the first position to the second position upon compaction of the vial adaptor.

9. The liquid transfer device of claim 8, wherein the valve actuator is configured to drive the valve from the first state when the valve actuator is in the first position to the second state when the valve actuator is in the second position upon compaction of the vial adaptor.

10. The liquid transfer device of claim 8, wherein the valve comprises an angled face configured to engage with the valve actuator.

11. The liquid transfer device of claim 6, further comprising a safety catch which is configured to prevent compaction of the vial adaptor in the non-compacted state.

12. The liquid transfer device of claim 1, further comprising a connector body having the IV spike, the vial adaptor and the IV port coupled thereto, wherein the valve is movable within the connector body between the first state and the second state.

13. The liquid transfer device of claim 12, further comprising a bore, the valve further comprising a locking protrusion, wherein the locking protrusion is configured to engage with the bore to prevent movement of the valve between the first state and the second state, wherein the locking protrusion is configured to deflect and disengage from the bore such that the valve is movable between the first state and the second state in the compacted state.
